(19) United States
(12) Patent Application Publication
(10) Pub. No.: US 2001/0032445 A1
(43) Pub. Date: Oct. 25, 2001

(54) Multi-layered dust filtration and collection system

(76) Inventors: Gary K. Wilder, Bloomington, IL (US); Dominic Propersi, Bloomington, IL (US)

Correspondence Address: Piper Marbury Rudnick & Wolfe, P.O. Box 64807, Chicago, IL, 60664-0807, US

(21) Appl. No.: 09/795,741

(22) Filed: Feb. 28, 2001

Related U.S. Application Data
(60) Provisional application No. 60/186,159, filed on Feb. 29, 2000.

(51) Int. Cl. B01D 46/02

(52) U.S. Cl. 55/382; 55/486

(57) ABSTRACT

A disposable or reusable multi-layer dust filtration and collection system having a highly air permeable inner filter ply of randomly intertangled, discontinuous microfibers of synthetic material, at least one outer ply of air permeable cellulose, synthetic, or cellulose/synthetic blended material, and an air permeable collar affixed to the outer surface of the outer ply material(s). The outer ply(s) of material are not only air permeable, but have high abrasion resistance and strength for high airflow velocity industrial applications, such as mining. The inner ply has high filtration efficiency to help retain hazardous airborne particulate matter, such as silica, from operators of the industrial machinery generating the matter.

### CLAIM OF PRIORITY

This application claims priority from U.S. Provisional patent application Ser. No. 60/186,159 filed Feb. 29 2000.

### BACKGROUND OF THE INVENTION

1. Field of Invention

This invention finds use in the field of collection bags, such as those used in vacuum cleaners and other debris collection devices. More particularly, this invention relates to a multilayered dust and particulate collection, filtration, and retention system for heavy industrial applications, such as mining, where collected particles are highly abrasive and heavy and collected under rigorous conditions.

2. Description of Prior Art

Typical collection bags consist of the bag itself and some type of means to attach and seal the bag to the collection unit (i.e. vacuum cleaner), such as a collar. The collection bag is regularly constructed of a single ply of material which allows the exhaustion of air generated during the vacuuming process, but does not allow the passage of dirt and other materials collected. However, such collection bags are unsuitable for heavy industrial operations, such as mining, where large particles and highly abrasive materials are collected, thus causing the bag to tear and spill its contents. Similarly, normal collection bags are not able to hold a great deal of weight of collected particulate. Furthermore, such bags cannot adequately filter particulate matter, such as silica, which is hazardous when airborne to persons working on or near the mining machinery.

### SUMMARY OF INVENTION

It is therefore an object of the present invention to provide a collection bag which is able to withstand the effects of abrasive particulate matter generated and collected during heavy industrial operations, such as mining.

It is a further object of the present invention to provide a collection bag which is able to filter particulate matter so that such matter is not introduced back into the work environment.

It is yet another object of the present invention and a feature thereof to provide a collection bag which is simple to produce and utilize in the appropriate work environments.

Currently, roof bolting equipment used in mining possesses a debris removal system comprised of a vacuum system, a dust tank, and an exhaust system. There are two problems with this system design: (1) there is an inadequate filtration system to filter the hazardous fine particulates, such as silica, and (2) when the dust tank is full, machinery operators have to clean out the box through rudimentary methods such as hands or tools, thus re-exposing them to the hazardous particles. Up until conception of the invention, there has been no method to resolve these system design deficiencies. The aforementioned features of the invention resolve the filtration as well as debris removal deficiencies.

The present invention features a multi-layer dust filtration and collection system able to be used in industrial applications, such as roof bolting machines used in mining. The system has high efficiency filtration characteristics while possessing significant strength and durability to not only resist damage due to mechanical erosion caused by the high velocity intake of abrasive mining debris and dust, but also the significant relative weight of retained debris. The invention can generally be described as a collection bag having two separate layers. The outer layer is comprised of a heavy “paper-like” material which has filtration properties. The material is thicker and stronger than typical bag material, such that is resists tears. The inner-layer is a synthetic “spun-bound” material such as REEMAY (E.I. DuPont de Nemours and Company). It has little to no inherent filtration properties, but serves to strengthen the bag further. Additionally, the properties of the inner-layer material acts as an abrasive which further breaks down the collected particles, such as sand, rock, and coal dust. The two layers are laminated together to additionally strengthen the bag, such that the bag is rated to hold up to 30 pounds of material without breakage. There is an inlet and collar for attachment to the collection machinery.

It should be noted that the materials, and thus the properties, of the inner and outer layers may be exchanged. Therefore, the inner layer serves to filter the collected dust and particles while the outer layer acts to strengthen the bag, and to a somewhat lesser extent, abrade the collected particles.

### BRIEF DESCRIPTION OF THE DRAWINGS

Specific embodiments of the invention have been chosen for purposes of illustration and description, and are shown in the accompanying drawing, forming a part of the specification wherein:

FIG. 1 is a top elevational view of the invention;

FIG. 2 is profile view of the invention, partly broken away to show the inner and outer plys in cross section; and

FIG. 3 is a plan view of a piece of the microfiber webbing forming the inner ply.

FIG. 4 is a perspective view of the inside of the dust tank filled with the present invention;

### DESCRIPTION OF PREFERRED EMBODIMENTS

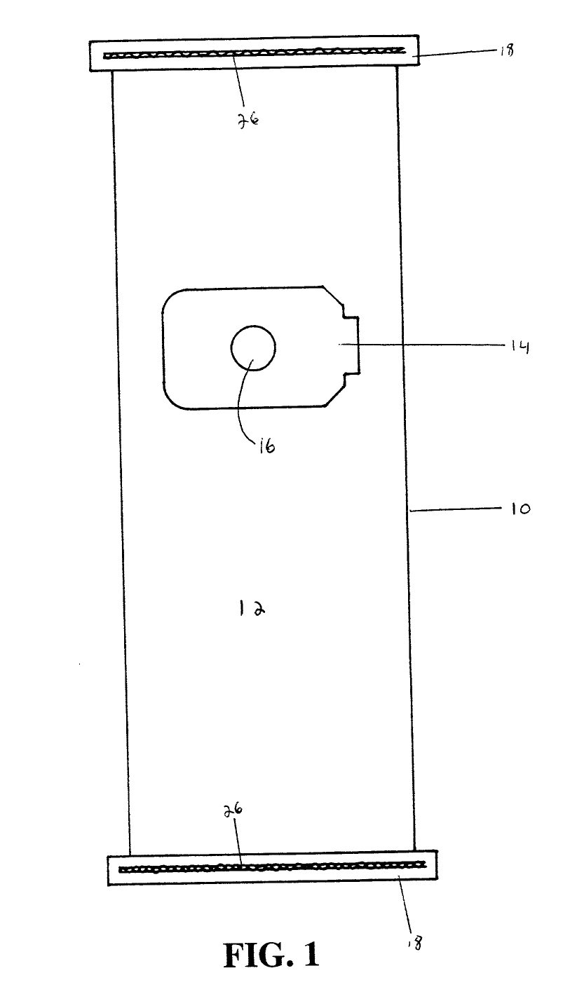

Referring to the FIG. 1, the collection bag 10 of the current invention is generally rectangle shaped, but may take another geometric form which is conveniently shaped to fit properly within the dust tank of a mining roof bolter or other industrial machinery of interest. The collection bag 10 is comprised of a two-ply bag 12 which is sealed at either end by strips 18. A support collar 14 is affixed to the bag material 12 at a suitable junction, again depending on the use of the collection bag 10. The collar 14 and the bag material 12 contain an aperture 16 therethrough which are in registry, such that the exhaust or output nozzle (not shown) of the roof bolter or other debris generating apparatus. The collar 14 may optionally contain a rubber gasket (not shown) around the perimeter of the aperture 16, which narrows the aperture 16 and provides a tighter fitting between the collection bag 10 and the output nozzle of the debris generating apparatus.

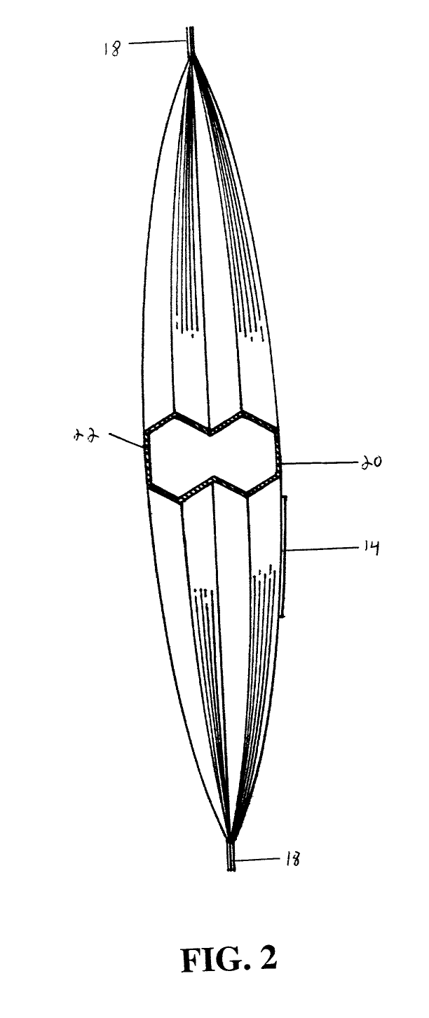

Now referencing FIG. 2, in the preferred embodiment, the invention is generally flat in front and rear elevation and oval in profile. The two-ply collection bag material 12 is formed of an outer ply layer 20 and an inner ply layer 22. As previously detailed, the inner ply layer 22 is comprised of a non-woven air filter formed of microfiber webbing and the outer layer(s) is formed of cellulose, synthetic, cellulose/synthetic blended material or any other material well known in the art. In the preferred embodiment of the invention, the inner ply is a web of about 7 millimeter in thickness formed of randomly intertangled synthetic polymeric microfibers that have an individual test weight of 15-40 g/m² and preferably an average weight of 23 g/m².

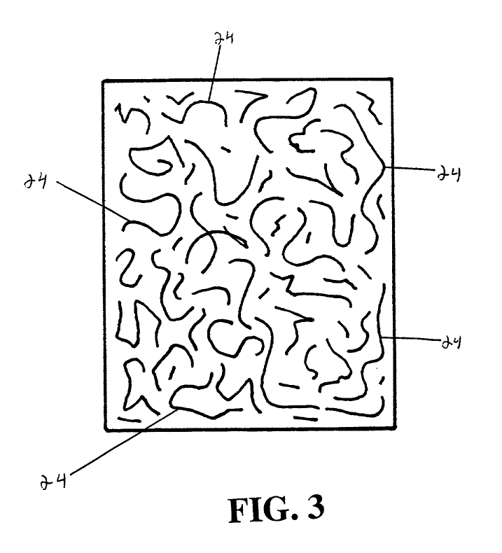

FIG. 3 illustrates the non-woven, microfiber webbing which constitutes the inner ply layer 22, and possibly the outer ply layer 20. The webbing is preferably formed of randomly intertangled, discontinuous fibers 24, formed from thermoplastic materials such as polypropylene, polyethylene, a mixture thereof, polyamides, or other known polymers

The material of the outer ply layer 20 may be cellulose, synthetic, cellulose/synthetic blended material or any other material well known in the art. A typical outer ply may, for example, comprise randomly intertangled cellulose and/or synthetic fibers bonded at fiber cross over joints by natural hydrogen bonding and reinforced with starch or latex binder to help bond the cellulose fibers. If 100% synthetic fibers are used, the bonding could be through air laid or thermal processes as known by those in the art. The ply(s) has a total average weight of 40-175 g/m², and a Frazier air permeability greater than 20 as measured at 0.5 inches H₂O pressure drop.

In the preferred embodiment of the invention, ends of the collection bag are finished by sealing the endfolds with a cellulose endstrips 18 and sewing with heavy gauge twine 26, such that the ends are reinforced from splitting or otherwise coming apart. The twine can be comprised of any material known in the art, such as cotton, wool, hemp, or other cellulose fiber.

In a preferred embodiment, the inner ply is laminated to the outer ply. The laminated material has a basis weight of 100 g/m², a Mullen burst strength of 72-80 psi, and a minimum filtration efficiency of 95% at 3 microns. The outer ply would be a synthetic composite material of wet laid cellulose/synthetic blend and the inner ply a web of intertangled synthetic polymeric microfibers.

In another embodiment, the inner ply is also laminated to the outer ply. The laminated material has a basis weight of 200 g/m², a Mullen burst strength of 72-80 psi, and a minimum filtration efficiency of 95% at 3 microns. The outer ply would be 100% wet laid, acrylic latex saturated cellulose. The inner ply is a spunbonded polyester, such as that available under the REEMAY trademark (E.I. DuPont de Nemours and Company).

As previously indicated, another embodiment of the invention is found by reversing the materials, and thus the properties, of the inner and outer layers, as described in the preferred embodiment. The inner layer is designed to filter dust and other particles, while the outer layer strengthens and reinforces the bag.

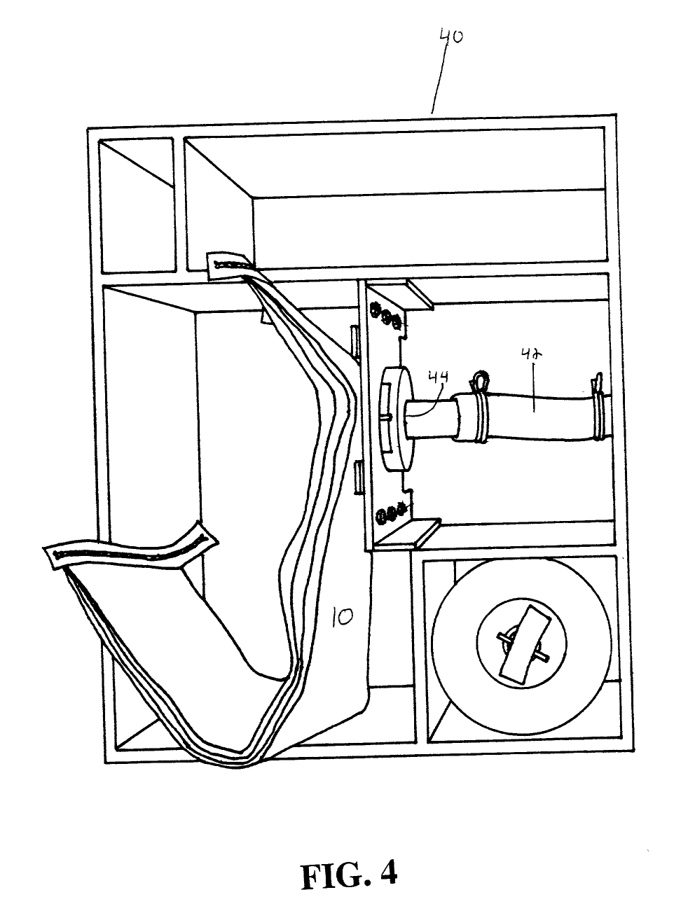

FIG. 4 illustrates a dust tank 40 from a roof bolter as used in mining operations. It contains a motor driven blower (not shown). The blower causes air, dirt, and debris to be extracted out of a drilling head (not shown) and to pass at a relatively high velocity and volume through a length of flexible, reinforced tubing 42 connected to a rigid inlet 44 and into the instant collection bag 10 contained within the dust tank 40. The invention is impervious to all but the very finest dust particles and so traps substantially all of the particles of dirt and debris in the air stream but is pervious to air so that clean air is discharged from the invention. It is also resists damage due to mechanical erosion caused by the high velocity intake of abrasive mining debris and dust, but also the significant relative weight of retained debris. In order to utilize the invention in industrial operations such as roof bolting equipment, it may be necessary to utilize retrofit fixtures so the collection bag has something to be affixed to. More specifically, for best results, the system should not be held by its collar simply by friction, the system should be inserted into a track assembly fixture or similar support.

In addition to the structures, sequences, and uses immediately described above, it will be apparent to those skilled in the art that other modifications and variations can be made the method of the instant invention without diverging from the scope, spirit, or teaching of the invention, such as reversing the materials of the inner and outer layers. Therefore, it is the intention of the inventors that the description of instant invention should be considered illustrative and the invention is to be limited only as specified in the claims and equivalents thereto.

What is claimed is:

1. A multi-layered collection bag comprising:
an first ply layer and an second ply layer which have been bonded together;
the first ply layer formed of a synthetic material comprised of a web of randomly intertangled and discontinuous microfibers;
the second ply layer formed from material selected from the group comprising natural, synthetic or natural/synthetic blend materials, said material being tear resistant and having a filtration efficiency of at least 95% at 3 microns; and
an inlet formed from an aperture through the first and second ply layers.

2. The multi-layered collection bag of claim 1, wherein the second ply layer has a Frazier air permeability greater than 20, as measured at 0.5 inches H₂O.

3. The multi-layered collection bag of claim 1, further comprising a support collar attached to said collection bag and having an opening which is in registry with said inlet.

4. The multi-layered collection bag of claim 1, wherein the first ply layer has an average weight of 23 g/m².

5. The multi-layered collection bag of claim 1, wherein the material of the first ply is selected from the group comprising polypropylene, polyethylene, and polyamides.

6. The multi-layered collection bag of claim 1, wherein the material of the second ply layer is a cellulose/synthetic blend.

7. The multi-layered collection bag of claim 1, Wherein the first layer is the inter ply layer and the second layer is the outer ply layer.
